(19) United States
(12) Patent Application Publication
(10) Pub. No.: US 2009/0102164 A1
(43) Pub. Date: Apr. 23, 2009

(54) Airbag module

(75) Inventors: Nick Eckert, Berlin (DE); Rafael Fagir, Berlin (DE); Frank Wollny, Berlin (DE)

Correspondence Address: FOLEY AND LARDNER LLP;SUITE 500, 3000 K STREET NW, WASHINGTON, DC, 20007, US

(73) Assignee: TAKATA-PETRI AG

(21) Appl. No.: 12/285,634

(22) Filed: Oct. 9, 2008

Related U.S. Application Data
(63) Continuation of application No. PCT/EP2007/003353, filed on Apr. 10, 2007.

(30) Foreign Application Priority Data
Apr. 11, 2006 (DE) 10 2006 017 751.7

(51) Int. Cl. B60R 21/237; B60R 21/205; B23P 11/00

(52) U.S. Cl. 280/728.1; 280/743.1; 29/428

(57) ABSTRACT

An apparatus for an airbag module, in particular for a motor vehicle, including a flexible airbag and a sleeve. The flexible airbag may be arranged in a multi-layered manner by folding and may be inflated with gas to protect a person. Before inflation, the airbag is arranged in a planar spread-out state such that the airbag extends along a predefinable surface. Further, the airbag is surrounded by an evacuated sleeve before inflation, such that the planar spread-out state of the airbag is dimensionally stable. In the evacuated state, the sleeve together with the airbag is configured to be mechanically deformable. Thus, a spatial shape produced by deformation of an airbag package including the sleeve and the airbag located therein is dimensionally stable.

### CROSS-REFERENCE TO RELATED APPLICATION

This application is a Continuation of International Patent Application No. PCT/EP2007/003353, filed Apr. 10, 2007, which was published in German as WO 2007/118699 and is incorporated herein by reference in its entirety.

### BACKGROUND

The present application relates generally to the field of an airbag module. More particularly, the present application relates to an airbag module for use in a motor vehicle.

### SUMMARY

One disclosed embodiment relates to an apparatus for an airbag module, in particular for a motor vehicle, including a flexible airbag and a sleeve. The flexible airbag may be arranged in a multi-layered manner by folding and may be inflated with gas to protect a person. Before inflation, the airbag is arranged in a planar spread-out state such that the airbag extends along a predefinable surface. Further, the airbag is surrounded by an evacuated sleeve before inflation, such that the planar spread-out state of the airbag is dimensionally stable. In the evacuated state, the sleeve together with the airbag is configured to be mechanically deformable. Thus, a spatial shape produced by deformation of an airbag package including the sleeve and the airbag located therein is dimensionally stable.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 shows an airbag package of the airbag module according to an exemplary embodiment.

FIG. 1A shows a modification of the airbag package shown in FIG. 1.

FIG. 2 shows a curved airbag package of the type shown in FIG. 1.

FIG. 3 shows a schematic sectional view of an airbag package bent-back twice, of the type shown in FIGS. 1 and 2.

FIG. 4 shows a schematic sectional view of an airbag package of the type shown in FIGS. 1 to 3, wherein the upper face of the airbag is facing the occupant to be protected and is folded.

FIG. 5 shows a schematic sectional view of an airbag package of the type shown in FIGS. 1 to 4, wherein an airbag is spread out in a planar manner and folded-in on an edge region of the airbag.

FIG. 6 shows a schematic sectional view of an airbag module including an airbag package of the type shown in FIGS. 1 to 5, wherein the airbag package is arranged in a depression of an instrument panel.

FIG. 7 shows a schematic perspective view of an airbag module of the type shown in FIG. 6, wherein the airbag is designed and provided to protect the knees of a vehicle occupant.

### DETAILED DESCRIPTION

According to an exemplary embodiment, an airbag module includes a flexible airbag that may be arranged in a multi-layered manner by folding. For example, the flexible airbag may consist of a woven fabric, a knitted fabric or a film-like material. Additionally, the flexible airbag may be inflated with gas to protect a person. Before inflation, the airbag, relative to an installed state, is arranged in a planar spread-out state such that it extends along a predefinable imaginary surface. The imaginary surface may have a curvature. An exemplary airbag module is disclosed in DE 199 04 320, which is herein incorporated by reference in its entirety.

In an airbag module of the aforementioned embodiment, a problem exists wherein the airbag is difficult to handle due to its flexibility (insufficient rigidity). As a result, the positioning and securing of the airbag at the place of installation is complicated and time-consuming. Therefore, an object of an embodiment described further below is to provide an airbag module with improved handling during mounting.

Accordingly, a sleeve is included that surrounds the airbag. Before inflation of the airbag, the sleeve is evacuated such that the planar spread-out state of the airbag is dimensionally stable. By the phrase “evacuation of the sleeve”, a process is understood in which a vacuum is produced in an interior surrounded by the sleeve, wherein an airbag is arranged in the sleeve in a planar spread-out state. As a result, the sleeve is closed. Subsequently, before inflation of the airbag a pressure is present in the interior of the sleeve. The pressure in the interior of the sleeve is substantially less than the pressure in the exterior surrounding the sleeve. Thus, during evacuation of the sleeve a vacuum is produced in the interior of the sleeve.

As a result, the airbag maintains its shape when positioned and secured to a carrier of the airbag. Further, the handling of the airbag during mounting is simplified. Moreover, even in the evacuated state, the sleeve together with the airbag can be configured to be mechanically deformable and/or manually deformable. Furthermore, the spatial shape produced by deformation of the airbag package is dimensionally stable. As a result, the airbag package may be brought into a final spatial shape at any time. For example, the airbag package may be brought into a final spatial shape shortly before securing the airbag package to a carrier (e.g. an instrument panel of a motor vehicle). In particular, the evacuated sleeve together with the airbag may be manually deformed due to the planar arrangement of the airbag in the evacuated sleeve. This is not the case with conventional airbag packages that are not of planar configuration, such as those found in driver airbag modules.

Preferably, the airbag extends in the planar spread-out state along a predefined imaginary surface such that over at least one part of the surface only two layers of the airbag are located on top of one another transversely to the surface. Preferably, over a large part of the surface (e.g. more than half of the surface), only two layers of the airbag are located on top of one another transversely to the surface.

The airbag in the planar spread-out state is either un-folded or only slightly folded once or twice. Preferably, no more than two layers of the airbag are arranged on top of one another transversely to the imaginary surface. Further, along the imaginary surface the airbag extends in the planar spread-out state (e.g., before inflation). The airbag comprises least one or more flexible and foldable airbag plates. The flexible and foldable airbag plates surround an interior of the airbag that may be filled with gas. The number of layers of the airbag in the planar spread-out state corresponds in this case to the number of intersecting points between a straight line extending transversely to the surface and the at least one airbag plate. The airbag plates can be constructed of a woven fabric, a knitted fabric, or a film-like material. Additionally, the airbag plates can be bonded, welded or stitched together.

According to an exemplary embodiment, transversely to the imaginary surface, at each point of the surface no more than four layers of the airbag are arranged on top of one another transversely to the surface. Thus, the airbag can be folded back once onto itself or even repeatedly (at different points), such that over a large part of the surface four layers of the airbag are located on top of one another transversely to the surface. More particularly, the airbag can be folded back onto itself in a congruent manner, such that four layers of the airbag are located on top of one another transversely to the surface.

According to a preferred exemplary embodiment, the two adjacent layers of the airbag in the evacuated state of the sleeve bear closely against one another. As a result, there are no gaps (spaces) between the individual layers.

According to an exemplary embodiment, the evacuated sleeve containing the airbag is less than 1 cm thick, transversely to the surface along which the airbag extends in the planar spread-out state. Thus, the airbag package including the evacuated sleeve and the airbag has an expansion of less than 1 cm transversely to the surface. Therefore, the surface that the airbag extents along can be curved. In other words, the thickness of less than 1 cm refers to the cross-sectional thickness of the airbag package.

According to an exemplary embodiment, the airbag module is configured for arranging on a planar region of a carrier, such that the airbag in the planar spread-out state extends along the planar region. Preferably, the planar region forms the base of a depression configured on the carrier. Further, a cover is included that extends along the imaginary surface and/or the airbag. The cover covers the airbag before inflation. Additionally, the cover can be configured to open along at least one openable region when the airbag presses against the cover during inflation. The cover can be a slush skin that is reinforced for improving the dimensional stability. The openable regions can be configured as tear lines, along which the cover tears in order to open the airbag. Further, the cover can be bonded to a peripheral edge region of the depression of the carrier.

Additionally, the sleeve that is evacuated before inflation of the airbag includes a first side extending along the imaginary surface. The first side, relative to an installed state of the airbag module, faces a person to be protected. Additionally, the sleeve includes a second side extending along a surface that extends parallel to the first side. The two sides are pressed against one another transversely to the surface by the vacuum present in the sleeve before inflation. Thus, the individual layers of the airbag located on top of one another and extending along the surface are pressed against one another transversely to the surface, thereby bearing closely against one another. As a result, the individual layers may not be displaced relative to one another along the surface.

According to a preferred exemplary embodiment, the first side includes an outermost peripheral first edge region. The second side includes an outermost peripheral second edge region via which the two sides are connected to one another, such that a sleeve is configured that may be arranged in a planar manner. Alternatively, the sleeve can include a convex curvature along a plane located perpendicular to the sleeve, relative to a person to be protected. The path of the curvature of the sleeve can, in this case, be adapted precisely to the path of a surface of a carrier on which the airbag may be mounted with the sleeve. As a result, the sleeve can bear against the carrier, in particular in a planar manner.

According to an exemplary embodiment, the sleeve includes an angled step in cross section. The aforementioned shapes are formed after the evacuation of the closed sleeve by mechanical deformation to the airbag package. Furthermore, the spatial shape of the sleeve may be set and/or influenced after evacuation by a specific shaping of the sleeve before evacuation. Due to the evacuation of the sleeve, the spatial shape of the airbag package produced in such a manner is dimensionally stable.

Additionally, a flange is included for fastening the airbag package to a carrier such that the evacuated state of the sleeve before inflation of the airbag is maintained. Alternatively, the fastening can take place such that the vacuum is only maintained until the mounting is completed.

Further, the airbag preferably includes an inflow opening through which gas may be introduced into the airbag for inflating the airbag in an inflow direction. The inflow opening includes a peripheral edge region defining the inflow opening, that serves to fasten the airbag to the flange.

The flange is preferably of annular configuration and also includes a peripheral edge region configured for bearing against the edge region of the inflow opening. Additionally, the flange is arranged in an interior of the airbag surrounded by the airbag. Further, the flange is configured to press the edge region of the inflow opening of the airbag. The flange additionally presses a part of the sleeve bearing against the edge region that lies counter to the inflow direction against the carrier and/or a module component arranged there. Thus, the airbag is secured to a carrier.

According to an exemplary embodiment, an airbag module arrangement includes a carrier, an airbag and an airbag module fastened to the carrier. Before inflation, the airbag extends along the carrier in the planar spread-out state. According to a preferred embodiment, the carrier includes a planar region. Before inflation, the airbag extends along the planar region in the planar spread-out state. Additionally, the airbag and the sleeve are secured to the planar region. Preferably, the planar region is configured as a base of a depression configured on the carrier. The depression can be covered by a cover before inflation of the airbag. The cover is configured to open along at least one openable region when the airbag presses against the cover during inflation. Further, the cover is fastened to a peripheral edge region of the depression (e.g., by bonding).

Furthermore, the carrier be as a motor vehicle part, a bodywork region (e.g. a pillar of the motor vehicle bodywork), a cladding element, a vehicle roof, a roof frame, a door, a seat, an instrument panel, or any other element that an airbag module can be fastened to.

Additionally, the airbag package can be arranged within a depression on the carriers of the aforementioned type and covered by a cover. A separate airbag pocket for retrofitting a motorcycle can also be included. The separate airbag pocket is preferably a pocket for fastening to a fuel tank of the motorcycle such that a planar region of the airbag pocket faces the motorcycle rider. Further, the airbag arranged on the region between the fuel tank of the motorcycle and the motorcycle rider is capable of being inflated in a dangerous situation.

According to an exemplary embodiment, a carrier in the form of a hood of a motor vehicle can be used. Thus, the airbag serves to protect the motor vehicle and a person colliding with the motor vehicle, and/or a collision object. When a rucksack or a motor cycle helmet is a carrier of the airbag module, then the airbag is preferably designed to support and to stabilize the neck region and upper spinal column region of the wearer of the rucksack and/or the motor cycle helmet.

According to an exemplary embodiment, a method is provided for producing an airbag module according to the disclosure. The method includes providing a flexible airbag, capable of being arranged in a multi-layered manner by folding, in a planar spread-out state. The method further includes enclosing the airbag with a sleeve which that be evacuated and evacuating the sleeve such that the airbag in the planar spread-out state extends in a dimensionally stable manner along a predefinable surface.

The airbag can extends (after enclosing the airbag with the sleeve and the evacuation of the sleeve) in the planar spread-out state in a dimensionally stable manner along a predefinable surface. Further, over at least one part of the surface only two layers of the airbag are located on top of one another transversely to the surface.

According to an exemplary embodiment, the evacuated sleeve containing the airbag is mechanically deformed. For example, the evacuate sleeve is deformed by pressing (possibly by heating) in a press such that the airbag after deformation in its planar spread-out state extends in a dimensionally stable manner along a further predefinable (imaginary) surface. Thus, while the surface can be configured in particular as a plane, the further surface may have a more complex path of curvature.

Thus, the airbag and/or the airbag package can be easily adapted to the geometry of the respective place of installation (carrier). The deformation can take place immediately before mounting on a carrier or immediately after the evacuation of the sleeve. The sleeve can be positioned in a preformed state due to its dimensional stability. As a result, the airbag package allows for a wide variety of variants with regard to a possible place of installation. Additionally, the airbag package may be kept in storage in the state already adapted to the respective place of use.

Furthermore, the airbag package can be moved into a curved spatial shape by a correspondingly formed sleeve and/or by already being shaped during evacuation.

In a method according to an exemplary embodiment, the airbag may initially be arranged in a planar spread-out state in the sleeve. The sleeve is subsequently evacuated and, after evacuation, is closed (e.g., by welding). The sleeve can be constructed of a (thermoplastic) plastics material. Instead of arranging the airbag in a planar spread-out state in the sleeve, the airbag can also be initially arranged in a planar spread-out state, and then surrounded by the sleeve. Thus, the airbag in the planar spread-out state may be positioned on a sleeve layer of the sleeve. The sleeve layer projects over an external peripheral edge of the airbag, such that the sleeve layer may be folded onto the airbag. As a result, the airbag in the planar spread-out state can be arranged between an upper and a lower portion of the sleeve layer. The upper and the lower portions of the sleeve layer are connected to the upper portion respectively comprising external edge regions that, during folding, are preferably brought to lie in a congruent manner on top of one another. By connecting the two outer edge regions of the sleeve layer, a sleeve is formed that encloses the airbag. Further, two portions that bear against one another of the two outer edge regions are able to remain disconnected for the purpose of forming a suction opening for evacuating the sleeve. After evacuation, the suction opening may be closed (by connecting the two portions to one another). Instead of a single sleeve layer, two sleeve layers may also be provided. The airbag can be arranged between the two sleeve layers. Additionally, the two sleeve layers can be connected to one another via their outermost peripheral edge regions for forming the sleeve, in particular by welding or bonding.

According to an exemplary embodiment, the airbag can be folded up and/or folded back in a defined. As a result, the deployment of the airbag during inflation can be influenced. Further, the size of a space can be made more accommodating to the airbag as a result of the folding. After being folded, the airbag package can also be shaped after evacuation. After the evacuation of the sleeve surrounding the airbag, the folds in the airbag are fixed. Thus, precisely definable and reproducible properties are provided in all integrated airbag modules. As a result, the opening behavior of the cover and the airbag positioning relative to an occupant to be protected during deployment of the airbag may be set in a consistent manner.

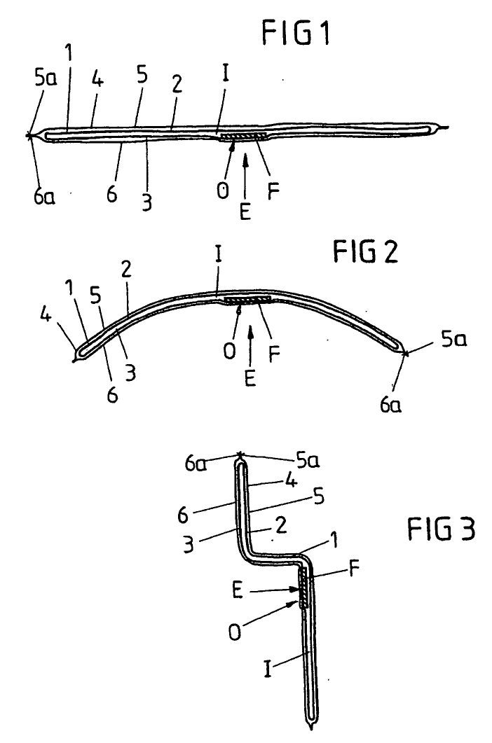

FIG. 1 shows a sectional view of an airbag package including an airbag 1. The airbag 1 is arranged in a planar spread-out state, such that it extends along an imaginary (planar) surface and is surrounded by a sleeve 4. The airbag 1 can be inflated with gas to protect a person. The gas may be introduced into the airbag 1 through an inflow opening O in an inflow direction E. The sleeve 4 can be evacuated before inflation of the airbag such that the planar spread-out state of the airbag 1 is dimensionally stable. Thus, the sleeve 4 also closes the inflow opening O of the airbag 1. During inflation of the airbag 1, a part of the sleeve 4 of the airbag 1 covering the inflow opening O is damaged by the hot gases. Thus, gas may enter an interior I surrounded by the airbag 1 via the inflow opening O. When using a cold gas, additional methods of cutting through the part of the sleeve 4 covering the inflow opening O can be provided. Further, via a flange F secured to the airbag, the airbag 1 together with the sleeve 4 may be secured to a carrier 7. The carrier 7 can be an instrument panel of a motor vehicle.

The airbag 1 includes, in the planar spread-out state before inflation, an upper face 2 facing an occupant to be protected and a lower face 3 remote from the occupant. Due to the evacuation of the sleeve 4, upper face 2 and lower face 3 extend parallel to one another and bear closely against one another. Thus, due to the vacuum prevailing in the sleeve 4, the upper face 2 and the lower face 3 of the airbag 1 may not be displaced relative to one another. As a result, a dimensional stability of the planar spread-out state of the airbag 1 before inflation occurs. Additionally, the flange F that fastens the airbag package is of planar annular configuration and bears with a peripheral edge region away from the interior I against a peripheral edge region of the inflow opening O of the airbag 1. The flange F can be secured to a connecting flange F′ on the carrier side such that the vacuum prevailing in the sleeve 4 before inflation is maintained.

The sleeve 4 enclosing the airbag 1 in the planar spread-out state includes at least one first side 5 and a second side 6. The two sides 5, 6 of the sleeve 4 extend along the imaginary surface, along which the airbag 1 in the planar spread-out state projects over an external peripheral edge of the airbag 1. The first side 5 is connected via an outermost peripheral first edge region 5a to an outermost peripheral second edge region 6a of the second side 6 of the sleeve 4 for the purpose of forming the sleeve 4. During production of the airbag module, the second side 6 of the sleeve 4 can be arranged in one plane. The airbag 1 can be spread out in a planar manner along the one plane, such that the lower face 3 of the airbag 1 bears against the second side 6 of the sleeve 4. Further, the outer peripheral edge region 6a of the second side 6 of the sleeve 4 projects over an outer peripheral edge of the airbag 1. On the upper face 2, the first side 5 is then positioned. The outer peripheral edge region 5a is connected to the outer peripheral second edge region 6a of the second side of the sleeve 4. The connection between outer peripheral edge region 5a and outer peripheral second edge region 6a can be achieved via a weld. Further, the sleeve 4 preferably consists of a thermoplastics material. A portion of the two edge regions 5a, 6a may remain disconnected, and thus surround a suction opening (not shown in FIG. 1) through which, after arranging the airbag 1 in the sleeve 4, the air located in the sleeve 4 may be suctioned. As a result of the vacuum present in the sleeve 4, the first side 5 of the sleeve 4 presses against the upper face 2 of the airbag 1, and/or the second side 6 presses against the lower face 3 of the airbag 1. Thus, the upper face 2 and the lower face 3 of the airbag 1 are pressed against one another, and may not be displaced relative to one another along the imaginary surface which the upper face 2 and the lower face 3 extend. Therefore, sufficient dimensional stability of the planar spread-out state of the airbag 1 results, after the evacuation of the sleeve 4. After evacuating the sleeve 4, the suction opening is closed. When using a suction opening that is formed between the two edge regions 5a, 6a, the suction opening may be closed by completely welding the two edge regions 5a, 6a of the sleeve 4.

According to an exemplary embodiment, the sleeve 4 for the airbag 1 may already be present and prefabricated in the form of a bag that is open on one side. Thus, before evacuation, the airbag 1 is packed into the sleeve 4 and arranged in the desired shape.

FIG. 1A shows a schematic sectional view of an airbag package of the type shown in FIG. 1, according to an exemplary embodiment. In contrast to FIG. 1, the airbag 1 is folded back once onto itself. For example, four layers of the airbag 1 are located on top of one another transversely to the surface that airbag 1 extends along. The airbag 1 may be spread-out initially in a planar manner (and without folds) on an underlayer, such that a lower face 1a of the airbag 1 bears against the underlayer and an upper face 1b of the airbag 1 is remote from the underlayer. Further, the airbag 1 is folded such that the upper face 1b comes to rest on itself and the lower face 1a of the airbag 1 forms the upper face 2 and the lower face 3 of the airbag 1 (see FIG. 1).

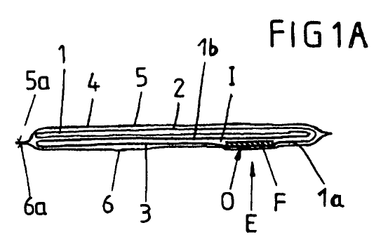

FIG. 2 shows a schematic sectional view of an airbag package of the type shown in FIG. 1, according to an exemplary embodiment. In contrast to FIG. 1, the sleeve 4 together with the airbag 1 arranged therein are curved in a convex manner in cross section. For example, the sleeve 4 includes a bulged portion in the direction of an occupant to be protected. The airbag package shown in FIG. 3 in cross section, including the sleeve 4 and the airbag 1, includes a path that is stepped and/or bent-back twice, according to an exemplary embodiment. For example, the sleeve 4 of planar configuration includes a first portion extends in an extension plane. The sleeve 4 also includes a central portion extending perpendicular to the extension plane that merges with a second portion of the sleeve 4 extending parallel to the extension plane. Thus, the first and the second portion are arranged offset to one another transversely to the extension plane. The spatial shapes of the airbag package and/or of the sleeve 4 shown in FIGS. 2 and 3, together with the airbag 1 arranged therein (flange F) represent only a selection of a plurality of possible spatial shapes of the airbag package (extending along a surface). The airbag package may be mechanically and reversibly deformed due to the evacuation of the sleeve 4 into a specific spatial shape that is dimensionally stable due to the evacuation of the sleeve 4. Thus, the airbag package may be adapted to any surface path of a carrier of the airbag package. The airbag package is only a few millimeters thick, preferably less than 1 cm. As a result, the airbag module can be used in a plurality of locations. More particularly, the airbag module can be used anywhere the available constructional space is defined in a main deployment direction of the airbag 1 extending transversely to the airbag 1 that is spread out in a planar manner. Further, where the constructional space is exceptionally planar, the gas generator G can be arranged at a distance from the airbag 1. Furthermore, the gas generator G may be connected via a gas supply device (for example a pipe) to the airbag 1.

FIG. 4 shows a schematic sectional view of a modification of the airbag module shown in FIGS. 1 to 3, according to an exemplary embodiment. In contrast to FIG. 1, the upper face 2 of the airbag 1 is not spread-out in a planar manner, but has folds extending along the upper face 2. The folds of the upper face 2 of the airbag 1 can be used for adapting to the size of a space for accommodating the airbag package. Further, the manner that the airbag 1 is deployed when filled with gas may be influenced by the path of the folds relative to the inflow opening O of the airbag 1. Additionally, during evacuation of the sleeve 4, the folds may not slip relative to one another as a result of the evacuation of the sleeve 4. For example, the positions of the folds relative to one another and/or to the inflow opening O (before inflation of the airbag 1) are constant. As a result of the prefolding, the positioning of the airbag 1 relative to an occupant to be protected can be adjusted and reproduced in a consistent manner. Furthermore, the airbag 1 can be folded in on an edge region according to FIG. 5 in order to adapt the airbag 1 in the planar spread-out state to an available constructional space.

As shown in FIG. 5, the single folding of the airbag 1 represents a specific design of the folding according to FIG. 1A. More particularly, the arrangement of the four airbag layers on top of one another is only present over a partial region of the surface that airbag 1 extends along. Furthermore, the airbag 1 can be folded in on a plurality of edge regions according to FIG. 5. For example, the airbag 1 can be folded in on two opposing edge regions. As a result of the repeated folding-in on edge regions, the airbag 1 can be arranged substantially in four layers over the surface.

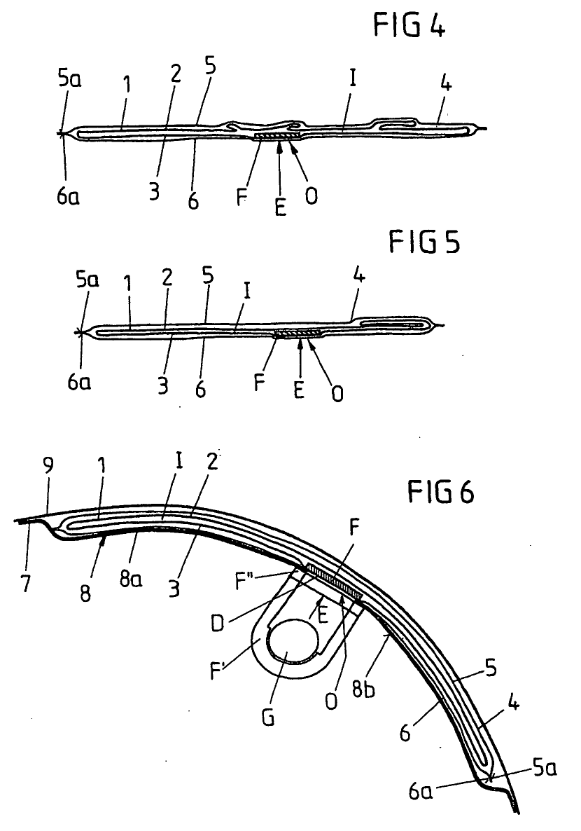

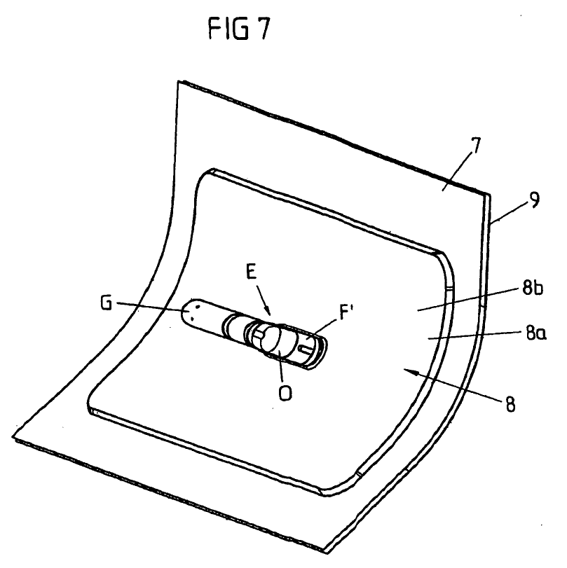

FIG. 6 shows a schematic sectional view of an airbag module of the type shown in FIGS. 1 to 5, according to an exemplary embodiment. The airbag module is mounted on a carrier. The carrier is in the form of an instrument panel 7. The instrument panel 7 is curved in a convex manner in cross section, the curved portion being formed toward an occupant to be protected. Further, the instrument panel 7 includes a planar depression 8 of uniform depth. The instrument panel also includes a base 8a curved in a convex manner, that forms a planar region to which the sleeve 4 with the airbag 1 located therein is secured. Thus, the second side 6 of the sleeve 4 is located in a planar manner against the base 8a of the depression 8. The airbag package arranged in the depression 8 fills the depression completely. On the base 8a of the depression 8, a through-opening D is configured such that the airbag 1 may be connected to a gas generator G in a gas-conducting manner. Additionally, a connecting flange F′ is secured to the through-opening D from a rear face 8b of the base 8a remote from the airbag 1. Thus, a holder is formed for the gas generator G that is arranged on the flange F′ such that gas emerging from the gas generator G may pass along the inflow direction E to the through-opening D of the base 8a. The flange F′ includes a peripheral edge region F″ that bears in a planar manner against a peripheral edge region of the rear face 8b edging the through opening D. The flange F configured corresponding to FIG. 1 is secured to the edge region F″ of the connecting flange F′ such that the flange F presses counter to the inflow direction E with a peripheral edge region against the edge region F″ of the connecting flange F′. Thus, the edge region of the inflow opening O as well as a part of the sleeve 4 covering the inflow opening O (and namely a part of the lower face 6 of the sleeve 4) is clamped along the inflow direction E between the base 8a of the instrument panel 7 and the flange F. For the connection between the flange F and the peripheral edge region F″ of the connecting flange F′, fastening elements projecting from the flange F can be used. The fastening elements projecting from the flange F are connected to the connecting flange F′ such that the vacuum prevailing in the sleeve 4 before inflation of the airbag 1 is maintained.

In order to cover the airbag 1 before inflation of the airbag 1, a cover (for example reinforced slush skin) can be arranged on the instrument panel 7 such that it covers the depression 8 of the instrument panel 7. The cover can be arranged between the depression 8 and the occupant to be protected in a main deployment direction, along which the airbag 1 during deployment moves toward an occupant to be protected. The cover 9 is connected (e.g, bonded), to a region of the instrument panel 7 surrounding the depression 8. Further, the cover 9 includes tear lines. When the airbag is filled with gas, the airbag expands and presses against the cover 9. As a result, the cover 9 tears open along the tear lines, thereby releasing airbag 1.

The airbag module shown in FIG. 6 is designed for use as a passenger airbag module. The use of the airbag module, however, is not restricted to the passenger region. The airbag module can be used anywhere, in particular where vertically (e.g., in a main deployment direction of the airbag and/or transversely to the surface) only a limited constructional space is available. The gas generator G may also be arranged at a distance from the through-opening D and/or at a distance from the airbag 1, and be connected thereto via a gas supply device (e.g., a flexible hose pipe).

FIG. 7 shows a perspective view of an airbag module of the type disclosed in FIG. 6, from the rear face 8b of the depression 8. In contrast to FIG. 6, the airbag module is designed and provided for use as a knee airbag module. Accordingly, the depression 8 of the instrument panel 7 is arranged approximately level with the knees of a vehicle occupant and faces the occupant. In contrast to FIG. 6, the flange F′ that is secured to the rear face 8b of the base 8a of the depression 8 is configured as a half-shell. An elongated, cylindrical gas generator G may be inserted into the flange F′ along the rear face 8b (i.e. transversely to the inflow direction E). As a result, the gas generator G may be mounted quickly.

The priority application, German Patent Application No. 10 2006 017 751.7 filed Apr. 11, 2006, including the specification, drawings, claims and abstract, is incorporated herein by reference in its entirety.

Given the disclosure of the application, one versed in the art would appreciate that there may be other embodiments and modifications within the scope and spirit of the application. Accordingly, all modifications attainable by one versed in the art from the present disclosure within the scope and spirit of the present application are to be included as further embodiments of the present application. The scope of the present application is to be defined as set forth in the following claims.

What is claimed is:

1. An airbag module for a motor vehicle, comprising:
an airbag configured to be arranged in a multi-layered manner by folding and to be inflated with gas, wherein the airbag is arranged before inflation in a planar spread-out state so that the airbag extends along a predefinable surface,
wherein the airbag before inflation is surrounded by an evacuated sleeve such that the planar spread-out state of the airbag is dimensionally stable,
wherein in the evacuated state, the sleeve together with the airbag is configured to be mechanically deformable, and wherein a respective spatial shape produced by deformation of an airbag package comprising the sleeve and the airbag located therein being dimensionally stable.

2. The airbag module of claim 1, wherein the airbag in its planar spread-out state is not folded or only slightly folded.

3. The airbag module of claim 1, wherein the airbag is arranged before inflation so that over at least one part of the surface only two layers of the airbag are located on top of one another transversely to the surface.

4. The airbag module of claim 1, wherein the airbag is arranged before inflation so that over a large part of the surface only two layers of the airbag are located on top of one another transversely to the surface.

5. The airbag module of claim 1, wherein at no point of the surface are more than two layers of the airbag located on top of one another transversely to the surface.

6. The airbag module of claim 1, wherein at no point of the surface are more than four layers of the airbag located on top of one another transversely to the surface.

7. The airbag module of claim 1, wherein the airbag in its planar spread-out state is folded back at least once onto itself, so that four layers of the airbag are located on top of one another transversely to the surface.

8. The airbag module of claim 3, wherein the layers of the airbag bear closely against one another.

9. The airbag module of claim 1, wherein an airbag package comprising the evacuated sleeve and the airbag located therein is less than 1 cm thick transversely to the surface.

10. The airbag module of claim 1, wherein the airbag module is configured to be arranged on a region of a carrier extending along the surface.

11. The airbag module of claim 10, wherein the region is a base of a depression formed on the carrier.

12. The airbag module of claim 1, further comprising a cover extending along the surface that covers the airbag before inflation, the cover being configured to open along at least one openable region when the airbag presses against the cover during inflation.

13. The airbag module of claim 1, wherein the sleeve has a first side extending along the surface that, relative to an installed state of the airbag module, faces a person to be protected and has a second side extending along the surface that extends substantially parallel to the first side.

14. The airbag module of claim 13, wherein the two sides are pressed against one another transversely to the surface by the vacuum prevailing in the sleeve before inflation, so that the individual layers of the airbag located on top of one another and extending along the surface are pressed against one another transversely to the surface and bear closely against one another.

15. The airbag module of claim 13, wherein the first side has an outermost first edge region and in that the second side has an outermost second edge region, the two sides being connected to one another via the two edge regions.

16. The airbag module of claim 1, wherein the sleeve has a convex curvature in cross section.

17. The airbag module of claim 1, wherein the sleeve has a step in cross section.

18. The airbag module of claim 10, further comprising a flange for fastening the airbag to the carrier.

19. The airbag module of claim 1, wherein the airbag includes an inflow opening through which gas may be introduced into the airbag for inflating the airbag in an inflow direction, the inflow opening having a peripheral edge region.

20. The airbag module of claim 18, wherein the flange is of annular configuration and includes a peripheral edge region that is provided for bearing against the edge region of the inflow opening such that the flange is arranged in an interior of the airbag surrounded by the airbag.

21. The airbag module of claim 19, wherein the flange is configured to press the edge region of the inflow opening of the airbag in the inflow direction against the carrier, for securing the airbag to a carrier.

22. The airbag module of claim 1, wherein the sleeve is of flexible configuration.

23. The airbag module of claim 1, wherein the sleeve is of film-like configuration, in particular made of a plastics material.

24. An airbag module arrangement comprising:
a carrier; and
an airbag module fastened thereto, wherein the airbag module comprises a flexible airbag that may be arranged in a multi-layered manner by folding and that may be inflated with gas, the airbag before inflation being arranged in a planar spread-out state such that the airbag extends along a predefinable surface,
wherein the airbag before inflation is surrounded by an evacuated sleeve such that the planar spread-out state of the airbag is dimensionally stable,
wherein in the evacuated state, the sleeve together with the airbag is configured to be mechanically deformable, a respective spatial shape produced by deformation of an airbag package comprising the sleeve and the airbag located therein being dimensionally stable; and
wherein the airbag before inflation extends along the carrier in its planar spread-out state.

25. The airbag module arrangement of claim 24, wherein the carrier includes a planar region along which the airbag, before inflation, extends in its planar spread-out state.

26. The airbag module arrangement of claim 25, wherein the planar region is a base of a depression configured on the carrier.

27. The airbag module arrangement of claim 26, further comprising a cover that covers the depression before inflation of the airbag, the cover being configured to open along at least one openable region when the airbag, during inflation, presses against the cover.

28. The airbag module arrangement of claim 24, wherein the carrier comprises one of the following components: a motor vehicle part, a bodywork region such as a pillar of the motor vehicle bodywork, a motor vehicle cladding element, a vehicle roof, a roof frame, a vehicle door, a vehicle seat, a steering wheel rim, an instrument panel, a hood, a glove compartment cover, a sun visor, a seatbelt, clothing, in particular motorcycle clothing, a motorcycle fuel tank, a separate airbag pocket for retrofitting a motorcycle, a rucksack, or a motorcycle helmet.

29. A method for producing an airbag module comprising a flexible airbag that may be inflated with gas to protect a person, wherein the method comprises the steps of:
providing the flexible airbag, able to be arranged in a multi-layered manner by folding, in a planar spread-out state,
wherein the airbag is enclosed with a sleeve that may be evacuated, and
wherein the sleeve is evacuated such that the airbag in its planar spread-out state extends in a dimensionally stable manner along a predefinable surface, the evacuated sleeve together with the airbag located therein, being mechanically deformed such that the airbag after deformation in its planar spread-out state, extends in a dimensionally stable manner along a further predefinable surface.
